(19) United States
(12) Patent Application Publication
(10) Pub. No.: US 2007/0122029 A1
(43) Pub. Date: May 31, 2007

(54) System and method for capturing visual data and non-visual data for multi-dimensional image display

(75) Inventor: Craig Mowry, Southampton, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Cedar Crest Partners, Inc.

(21) Appl. No.: 11/481,526

(22) Filed: Jul. 6, 2006

Related U.S. Application Data
(60) Provisional application No. 60/696,829, filed on Jul. 6, 2005.
(60) Provisional application No. 60/701,424, filed on Jul. 22, 2005.
(60) Provisional application No. 60/702,910, filed on Jul. 27, 2005.
(60) Provisional application No. 60/711,345, filed on Aug. 25, 2005.
(60) Provisional application No. 60/710,868, filed on Aug. 25, 2005.
(60) Provisional application No. 60/712,189, filed on Aug. 29, 2005.
(60) Provisional application No. 60/727,538, filed on Oct. 16, 2005.
(60) Provisional application No. 60/732,347, filed on Oct. 31, 2005.
(60) Provisional application No. 60/739,142, filed on Nov. 22, 2005.
(60) Provisional application No. 60/739,881, filed on Nov. 25, 2005.
(60) Provisional application No. 60/750,912, filed on Dec. 15, 2005.

(51) Int. Cl. G06K 9/00

(52) U.S. Cl. 382/154

(57) ABSTRACT

The present invention includes a system for capturing and screening multidimensional images. In an embodiment, a capture and recording device is provided, wherein distance data of visual elements represented visually within captured images are captured and recorded. Further, an allocation device that is operable to distinguish and allocate information within the captured image is provide. Also, a screening device is included that is operable to display the captured images, wherein the screening device includes a plurality of displays to display images in tandem, wherein the plurality of displays display the images at selectively different distances from a viewer.

### CROSS-REFERENCE TO RELATED APPLICATIONS

The present application is based on and claims priority to U.S. Provisional Application Ser. No. 60/696,829, filed on Jul. 6, 2005 and entitled “METHOD, SYSTEM AND APPARATUS FOR CAPTURING VISUALS AND/OR VISUAL DATA AND SPECIAL DEPTH DATA RELATING TO OBJECTS AND/OR IMAGE ZONES WITHIN SAID VISUALS SIMULTANEOUSLY,” U.S. Provisional Application Ser. No. 60/701,424, filed on Jul. 22, 2005 and entitled “METHOD, SYSTEM AND APPARATUS FOR INCREASING QUALITY OF FILM CAPTURE,” U.S. Provisional Application Ser. No. 60/702,910, filed on Jul. 27, 2005 and entitled “SYSTEM, METHOD AND APPARATUS FOR CAPTURING AND SCREENING VISUALS FOR MULTI-DIMENSIONAL DISPLAY,” U.S. Provisional Application Ser. No. 60/711,345, filed on Aug. 25, 2005 and entitled “SYSTEM, METHOD APPARATUS FOR CAPTURING AND SCREENING VISUALS FOR MULTI-DIMENSIONAL DISPLAY (ADDITIONAL DISCLOSURE),” U.S. Provisional Application Ser. No. 60/710,868, filed on Aug. 25, 2005 and entitled “A METHOD, SYSTEM AND APPARATUS FOR INCREASING QUALITY OF FILM CAPTURE,” U.S. Provisional Application Ser. No. 60/712,189, filed on Aug. 29, 2005 and entitled “A METHOD, SYSTEM AND APPARATUS FOR INCREASING QUALITY AND EFFICIENCY OF FILM CAPTURE,” U.S. Provisional Application Ser. No. 60/727,538, filed on Oct. 16, 2005 and entitled “A METHOD, SYSTEM AND APPARATUS FOR INCREASING QUALITY OF DIGITAL IMAGE CAPTURE,” U.S. Provisional Application Ser. No. 60/732,347, filed on Oct. 31, 2005 and entitled “A METHOD, SYSTEM AND APPARATUS FOR INCREASING QUALITY AND EFFICIENCY OF FILM CAPTURE WITHOUT CHANGE OF FILM MAGAZINE POSITION,” U.S. Provisional Application Ser. No. 60/739,142, filed on Nov. 22, 2005 and entitled “DUAL FOCUS,” U.S. Provisional Application Ser. No. 60/739,881, filed on Nov. 25, 2005 and entitled “SYSTEM AND METHOD FOR VARIABLE KEY FRAME FILM GATE ASSEMBLAGE WITHIN HYBRID CAMERA ENHANCING RESOLUTION WHILE EXPANDING MEDIA EFFICIENCY,” U.S. Provisional Application Ser. No. 60/750,912, filed on Dec. 15, 2005 and entitled “A METHOD, SYSTEM AND APPARATUS FOR INCREASING QUALITY AND EFFICIENCY OF (DIGITAL) FILM CAPTURE,” the entire contents of which are hereby incorporated by reference. This application further incorporates by reference in its entirety U.S. patent application Ser. No. 11/473,570, filed Jun. 22, 2006, entitled “SYSTEM AND METHOD FOR DIGITAL FILM SIMULATION”, U.S. patent application Ser. No. 11/472,728, filed Jun. 21, 2006, entitled “SYSTEM AND METHOD FOR INCREASING EFFICIENCY AND QUALITY FOR EXPOSING IMAGES ON CELLULOID OR OTHER PHOTO SENSITIVE MATERIAL”, U.S. patent application Ser. No. 11/447,406, entitled “MULTI-DIMENSIONAL IMAGING SYSTEM AND METHOD,” filed on Jun. 5, 2006, and U.S. patent application Ser. No. 11/408,389, entitled “SYSTEM AND METHOD TO SIMULATE FILM OR OTHER IMAGING MEDIA” and filed on Apr. 20, 2006, the entire contents of both of which are as if set forth herein in their entirety.

### BACKGROUND OF THE INVENTION

1. Field of the Invention

The present invention relates to imaging and, more particularly, to capturing visuals and spatial data for providing image manipulation options such as for multi-dimensional display.

2. Description of the Related Art

As cinema and television technology converge, audio-visual choices, such as display screen size, resolution, and sound, among others, have improved and expanded, as have the viewing options and quality of media, for example, presented by digital video discs, computers and over the internet. Developments in home viewing technology have negatively impacted the value of the cinema (e.g., movie theater) experience, and the difference in display quality between home viewing and cinema viewing has minimized to the point of potentially threatening the cinema screening venue and industry entirely. The home viewer can and will continue to enjoy many of the technological benefits once available only in movie theaters, thereby increasing a need for new and unique experiential impacts exclusively in movie theaters.

When images are captured in a familiar, prior art “two-dimensional” format, such as common in film and digital cameras, the three-dimensional reality of objects in the images is, unfortunately, lost. Without actual image aspects' special data, the human eyes are left to infer the depth relationships of objects within images, including images commonly projected in movie theaters and presented on television, computers and other displays. Visual clues, or “cues,” that are known to viewers, are thus allocated “mentally” to the foreground and background and in relation to each other, at least to the extent that the mind is able to discern. When actual objects are viewed by a person, spatial or depth data are interpreted by the brain as a function of the offset position of two eyes, thereby enabling a person to interpret depth of objects beyond that captured two-dimensionally, for example, in prior art cameras. That which human perception cannot automatically “place,” based on experience and logic, is essentially assigned a depth placement in a general way by the mind of a viewer in order to allow the visual to make “spatial sense” in human perception.

In the prior art, techniques such as sonar and radar are known that involve sending and receiving signals and/or electronically generated transmissions to measure a spatial relationship of objects. Such technology typically involves calculating the difference in “return time” of the transmissions to an electronic receiver, and thereby providing distance data that represents the distance and/or spatial relationships between objects within a respective measuring area and a unit that is broadcasting the signals or transmissions. Spatial relationship data are provided, for example, by distance sampling and/or other multidimensional data gathering techniques and the data are coupled with visual capture to create three-dimensional models of an area.

Currently, no system or method exists in the prior art to provide aesthetically superior multi-dimensional visuals that incorporate visual data captured, for example, by a camera, with actual spatial data relevant to aspects of the visual and including subsequent digital delineation between image aspects to present an enhanced, layered display of multiple images and/or image aspects.

### SUMMARY

In one embodiment, the present invention comprises a method for providing multi-dimensional visual information, and capturing an image with a camera, wherein the image includes visual aspects. Further, spatial data are captured relating to the visual aspects, and image data is captured from the captured image. Finally, the method includes selectively transforming the image data as a function of the spatial data to provide the multi-dimensional visual information.

In another embodiment, the invention comprises a system for capturing a lens image that includes a camera operable to capture the lens image. Further, a spatial data collector is included that is operable to collect spatial data relating to at least one visual element within the captured visual. Moreover, a computing device is included that is operable to use the spatial data to distinguish three-dimensional aspects of the captured visual.

In yet another embodiment, the invention includes a system for capturing and screening multidimensional images. A capture and recording device is provided, wherein distance data of visual elements represented visually within captured images are captured and recorded. Further, an allocation device that is operable to distinguish and allocate information within the captured image is provide. Also, a screening device is included that is operable to display the captured images, wherein the screening device includes a plurality of displays to display images in tandem, wherein the plurality of displays display the images at selectively different distances from a viewer.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a plurality of cameras and depth-related measuring devices that operate on various image aspects;

FIG. 2 shows an example photographed mountain scene having simple and distinct foreground and background elements;

FIG. 3 illustrates the mountain scene shown in FIG. 2 with example spatial sampling data applied thereto;

FIG. 4 illustrates the mountain scene shown in FIG. 3 with the foreground elements of the image that are selectively separated from the background elements;

FIG. 5 illustrates the mountain scene shown in FIG. 3 with the background elements of the image that are selectively separated from the foreground elements; and

FIG. 6 illustrates a cross section of a relief map created by the collected spatial data relative to the visually captured image aspects.

### DESCRIPTION OF THE EMBODIMENTS

Preferably, a system and method is provided that provides spatial data, such as captured by a spatial data sampling device, in addition to a visual scene, referred to herein, generally as a “visual,” that is captured by a camera. Preferably, a visual as captured by the camera is referred to herein, generally, as an “image.” Visual and spatial data are preferably collectively provided such that data regarding three-dimensional aspects of a visual can be used, for example, during post-production processes. Moreover, imaging options for affecting “two-dimensional” captured images are provided with reference to actual, selected non-image data related to the images; this to enable a multi-dimensional appearance of the images, further providing other image processing options.

In an embodiment, a multi-dimensional imaging system is provided that includes a camera and further includes one or more devices operable to send and receive transmissions to measure spatial and depth information. Moreover, a data management module is operable to receive spatial data and to display the distinct images on separate displays.

As used herein, the term, “module” refers, generally, to one or more discrete components that contribute to the effectiveness of the present invention. Modules can operate or, alternatively, depend upon one or more other modules in order to function.

Preferably, computer executed instructions (e.g., software) are provided to selectively allocate foreground and background (or other differing image relevant priority) aspects of the scene, and to separate the aspects as distinct image information. Moreover, known methods of spatial data reception are performed to generate a three-dimensional map and generate various three-dimensional aspects of an image.

A first of the plurality of media may be used, for example, film to capture a visual in image(s), and a second of the plurality of media may be, for example, a digital storage device. Non-visual, spatial related data may be stored in and/or transmitted to or from either media, and are preferably used during a process to modify the image(s) by cross-referencing the image(s) stored on one medium (e.g., film) with the spatial data stored on the other medium (e.g., digital storage device).

Computer software is preferably provided to selectively cross-reference the spatial data with respective image(s), and the image(s) can be modified without a need for manual user input or instructions to identify respective portions and spatial information with regard to the visual. Of course, one skilled in the art will recognize that all user input, for example, for making aesthetic adjustments, are not necessarily eliminated. Thus, the software preferably operates substantially automatically. A computer operated “transform” program may operate to modify originally captured image data toward a virtually unlimited number of final, displayable “versions,” as determined by the aesthetic objectives of the user.

In a preferred embodiment, a camera coupled with a depth measurement element is provided. The camera may be one of several types, including motion picture, digital, high definition digital cinema camera, television camera, or a film camera. In one embodiment, the camera is preferably a “hybrid camera,” such as described and claimed in U.S. patent application Ser. No. 11/447,406, filed on Jun. 5, 2006, and entitled “MULTI-DIMENSIONAL IMAGING SYSTEM AND METHOD.” Such a hybrid camera preferably provides a dual focus capture, for example for dual focus screening. In accordance with a preferred embodiment of the present invention, the hybrid camera is provided with a depth measuring element, accordingly. The depth measuring element may provide, for example, sonar, radar or other depth measuring features.

Thus, preferably a hybrid camera is operable to receive both image and spatial relation data of objects occurring within the captured image data. The combination of features enables additional creative options to be provided during post production and/or screening processes. Further, the image data can be provided to audiences in a varied way from conventional cinema projection and/or television displays.

In one embodiment, a hybrid camera, such as a digital high definition camera unit is configured to incorporate within the camera's housing a depth measuring transmission and receiving element. Depth-related data are preferably received and selectively logged according to visual data digitally captured by the same camera, thereby selectively providing depth information or distance information from the camera data that are relative to key image zones captured.

In an embodiment, depth-related data are preferably recorded on the same tape or storage media that is used to store digital visual data. The data (whether or not recorded on the same media) are time code or otherwise synchronized for a proper reference between the data relative to the corresponding visuals captured and stored, or captured and transmitted, broadcast, or the like. As noted above, the depth-related data may be stored on media other than the specific medium on which visual data are stored. When represented visually in isolation, the spatial data provide a sort of “relief map” of the framed image area. As used herein, the framed image area is referred to, generally, as an image “live area.” This relieve map may then be applied to modify image data at levels that are selectively discreet and specific, such as for a three-dimensional image effect, as intended for eventual display.

Moreover, depth-related data are optionally collected and recorded simultaneously while visual data are captured and stored. Alternatively, depth data may be captured within a close time period to each frame of digital image data, and/or video data are captured. Further, as disclosed in the above-identified provisional and non-provisional pending patent applications to Mowry that relate to key frame generation of digital or film images to provide enhanced per-image data content affecting for example, resolution, depth data are not necessarily gathered relative to each and every image captured. An image inferring feature for existing images (e.g., for morphing) may allow fewer than 24 frames per second, for example, to be spatially sampled and stored during image capture. A digital inferring feature may further allow periodic spatial captures to affect image zones in a number of images captured between spatial data samplings related to objects within the image relative to the captured lens image. Acceptable spatial data samplings are maintained for the system to achieve an acceptable aesthetic result and effect, while image “zones” or aspects shift between each spatial data sampling. Naturally, in a still camera, or single frame application of the present invention, a single spatial gathering, or “map” is preferably gathered and stored per individual still image captured.

Further, other imaging means and options as disclosed in the above-identified provisional and non-provisional pending patent applications to Mowry, and as otherwise known in the prior art, may be selectively coupled with the spatial data gathering imaging system described herein. For example, differently focused (or otherwise different due to optical or other image altering affect) versions of a lens gathered image are captured that may include collection of spatial data disclosed herein. This may, for example, allow for a more discrete application and use of the distinct versions of the lens visual captured as the two different images. The key frame approach, such as described above, increases image resolution (by allowing key frames very high in image data content, to infuse subsequent images with this data) and may also be coupled with the spatial data gathering aspect herein, thereby creating a unique key frame generating hybrid. In this way, the key frames (which may also be those selectively captured for increasing overall imaging resolution of material, while simultaneously extending the recording time of conventional media, as per Mowry) may further have spatial data related to them saved. The key frames are thus potentially not only for visual data, but key frames for other aspects of data related to the image allowing the key frames to provide image data and information related to other image details; an example of such is image aspect allocation data (with respect to manifestation of such aspects in relation to the viewer's position).

As disclosed in the above-identified provisional and non-provisional pending patent applications to Mowry, post production and/or screening processes are enhanced and improved with additional options as a result of such data that are additional to visual captured by a camera. For example, a dual screen may be provided for displaying differently focused images captured by a single lens. In accordance with an embodiment herein, depth-related data are applied selectively to image zones according to a user's desired parameters. The data are applied with selective specificity and/or priority, and may include computing processes with data that are useful in determining and/or deciding which image data is relayed to a respective screen. For example, foreground or background data may be selected to create a viewing experience having a special effect or interest. In accordance with the teachings herein, a three-dimensional visual effect can be provided as a result of image data occurring with a spatial differential, thereby imitating a lifelike spatial differential of foreground and background image data that had occurred during image capture, albeit not necessarily with the same distance between the display screens and the actual foreground and background elements during capture.

User criteria for split screen presentation may naturally be selectable to allow a project, or individual “shot,” or image, to be tailored (for example dimensionally) to achieve desired final image results. The option of a plurality of displays or displaying aspects at varying distances from viewer(s) allows for the potential of very discrete and exacting multidimensional display. Potentially, an image aspect as small or even smaller than a single “pixel” for example, may have its own unique distance with respect to the position of the viewer(s), within a modified display, just as a single actual visual may involve unique distances for up to each and every aspect of what is being seen, for example, relative to the viewer or the live scene, or the camera capturing it.

Preferably, depth-related data collected by the depth measuring equipment provided in or with the camera enables special treatment of the overall image data and selected zones therein. For example, replication of the three dimensional visual reality of the objects is enabled as related to the captured image data, such as through the offset screen method disclosed in the provisional and non-provisional patent applications described above, or, alternatively, by other known techniques. The existence of additional data relative to the objects captured visually thus provides a plethora of post production and special treatment options that would be otherwise lost in conventional filming or digital capture, whether for the cinema, television or still photography. Further, different image files created from a single image and transformed in accordance with spatial data may selectively maintain all aspects of the originally captured image in each of the new image files created. Particular modifications are preferably imposed in accordance with the spatial data to achieve the desired screening effect, thereby resulting in different final image files that do not necessarily “drop” image aspects to become mutually distinct.

In yet another configuration of the present invention, secondary (additional) spatial/depth measuring devices may be operable with the camera without physically being part of the camera or even located within the camera's immediate physical vicinity. Multiple transmitting/receiving (or other depth/spatial and/or 3D measuring devices) can be selectively positioned, such as relative to the camera, in order to provide additional location, shape and distance data (and other related positioning and shape data) of the objects within the camera's lens view to enhance the post production options, allowing for data of portions of the objects that are beyond the camera lens view for other effects purposes and digital work.

In an embodiment, a plurality of spatial measuring units are positioned selectively relative to the camera lens to provide a distinct and selectively detailed three-dimensional data map of the environment and objects related to what the camera is photographing. The data map is preferably used to modify the images captured by the camera and to selectively create a unique screening experience and visual result that is closer to an actual human experience, or at least a layered multi-dimensional impression beyond provided in two-dimensional cinema. Further, spatial data relating to an image may allow for known imaging options that merely three-dimensional qualities in an image to be “faked” or improvised without even “some” spatial data, or other data beyond image data providing that added dimension of image relevant information. More than one image capturing camera may further be used in collecting information for such a multi-position image and spatial data gathering system.

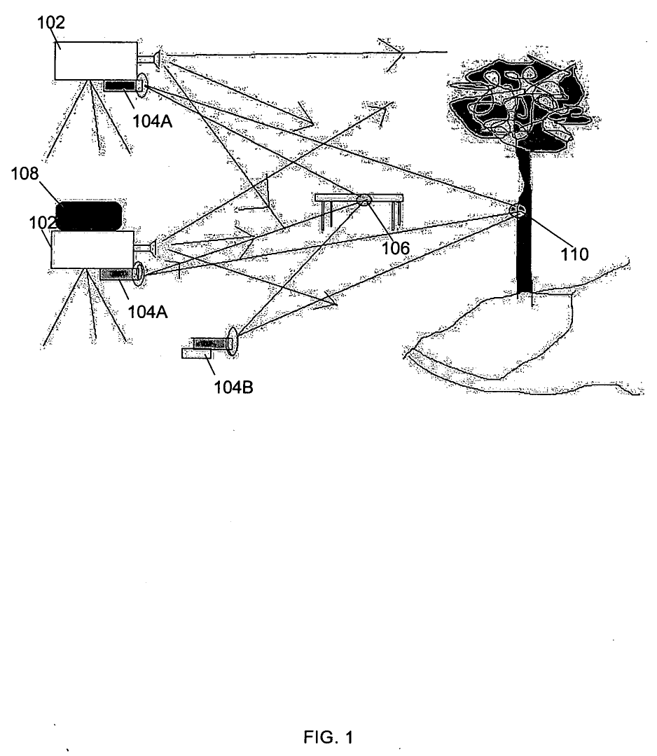

Referring now to the drawing figures, in which like reference numerals refer to like elements, FIG. 1 illustrates cameras 102 that may be formatted, for example, as film cameras or high definition digital cameras, and are preferably coupled with single or multiple spatial data sampling devices 104A and 104B for capturing image and spatial data of an example visual of two objects: a tree and a table. In the example shown in FIG. 1, spatial data sampling devices 104A are coupled to camera 102 and spatial data sampling device 104B is not. Foreground spatial sampling data 106 and background spatial sampling data 110 enable, among other things, potential separation of the table from the tree in the final display, thereby providing each element on screening aspects at differing depth/distances from a viewer along the viewer's line-of sight. Further, background sampling data 110 provide the image data processing basis, or actual “relief map” record of selectively discreet aspects of an image, typically related to discernable objects (e.g., the table and tree shown in FIG. 1) within the image captured. Image high definition recording media 108 may be, for example, film or electronic media, that is selectively synched with and/or recorded in tandem with spatial data provided by spatial data sampling devices 104.

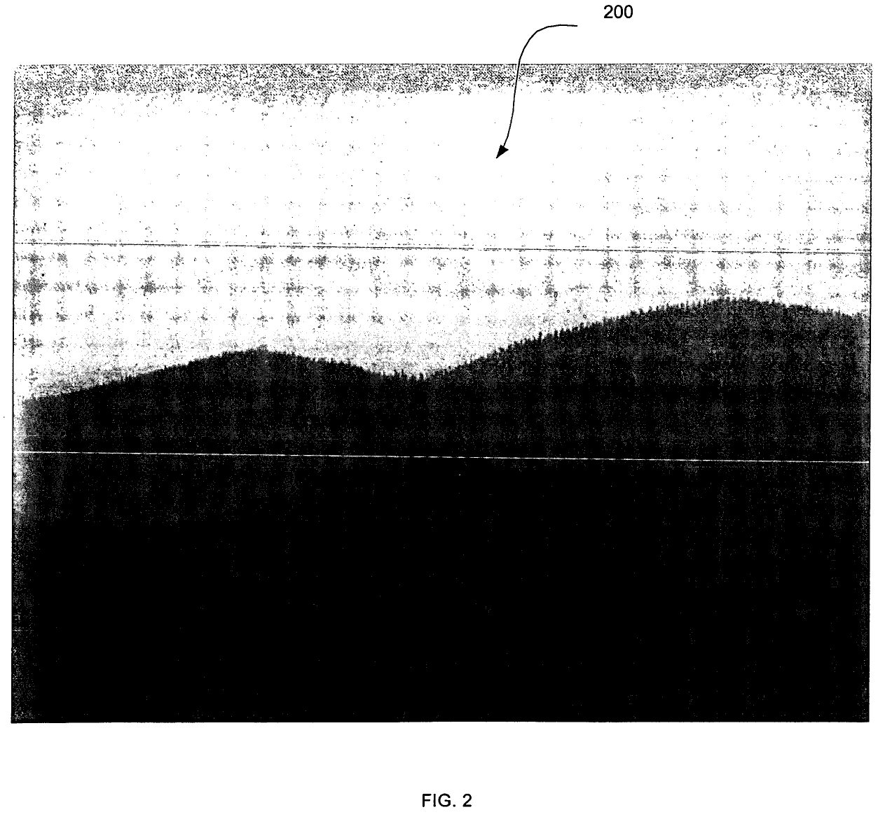

FIG. 2 shows an example photographed mountain scene 200 having simple and distinct foreground and background elements that are easily “placed” by the human mind. The foreground and background elements are perceived in relation to each other by the human mind, due to clear and familiar spatial depth markers/clues.

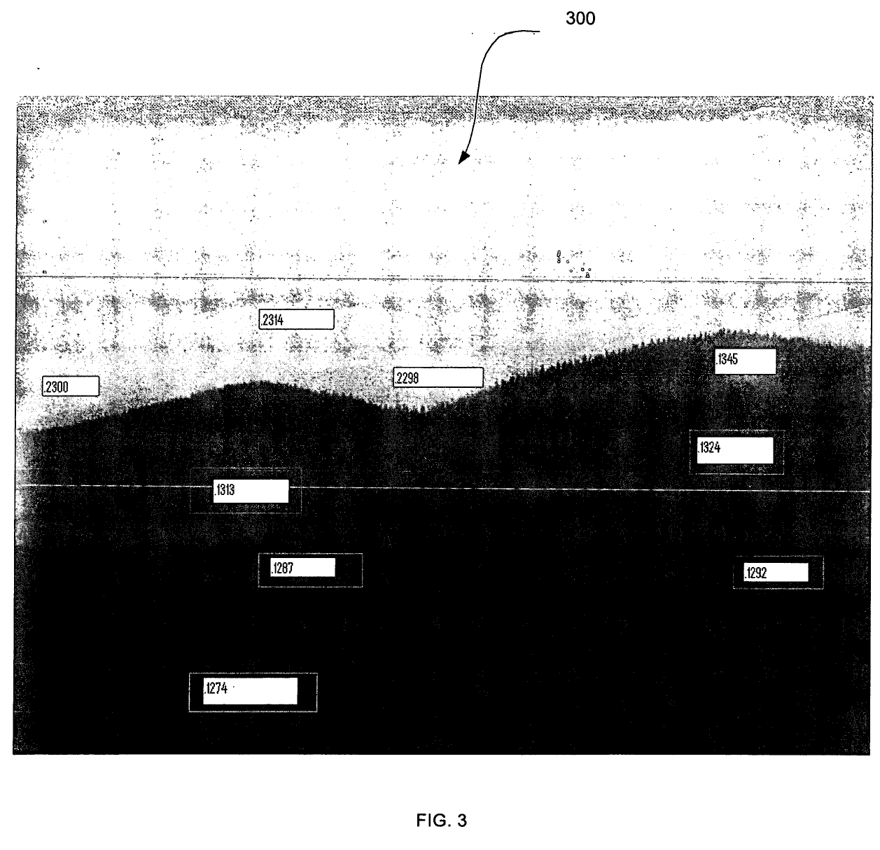

FIG. 3 illustrates the visual mountain scene 300 shown in FIG. 2 with example spatial sampling data applied to the distinct elements of the image. Preferably, a computing device used a specific spatial depth data transform program for subsequent creation of distinct image data files for selective display at different depth distances in relation to a viewer's position.

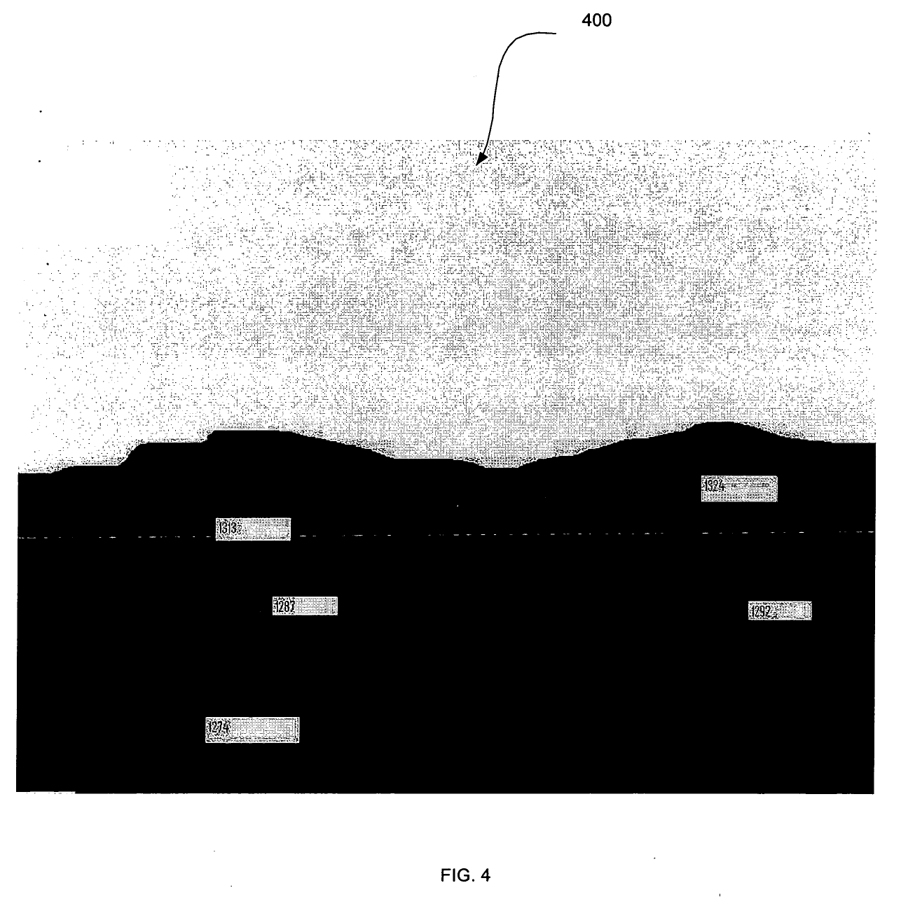

FIG. 4 illustrates image 400 that corresponds with visual mountain scene 300 (shown in FIG. 3) with the “foreground” elements of the image that are selectively separated from the background elements as a function of the spatial sampling data applied thereto. The respective elements are useful in the creation of distinct, final display image information.

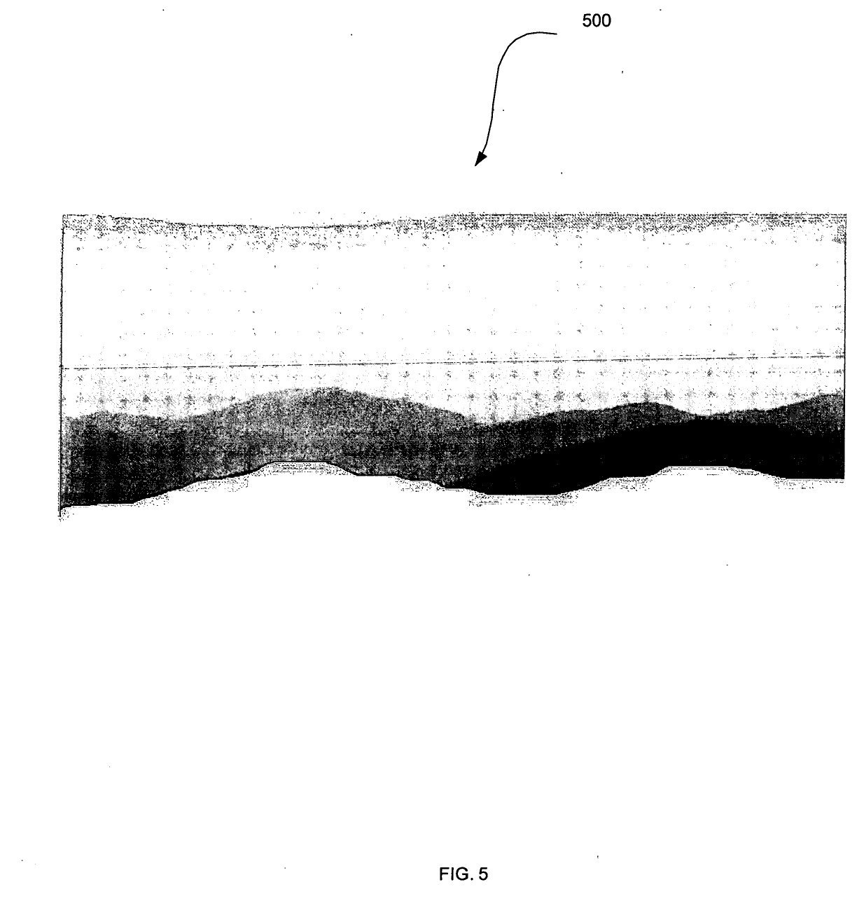

FIG. 5 illustrates image 500 that corresponds with visual mountain scene 300 (shown in FIG. 3) with the background elements of the image that are selectively separated from the foreground elements as a function of the spatial sampling data applied thereto. FIG. 5 illustrates the background elements, distinguished in a “two depth” system, for distinct display and distinguished from the foreground elements. The layers of mountains demonstrate an unlimited potential of spatially defined image aspect delineation, as a “5 depths” screening system, for example, would have potentially allowed each distinct “mountain range aspects” and background sky, to occupy its own distinct display position with respect to a viewer's position, based on distance from viewer along the viewer's line-of-sight.

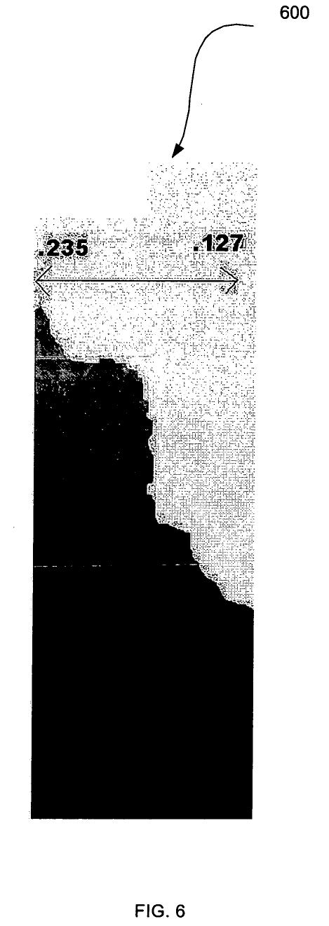

FIG. 6 demonstrates a cross section 600 of a relief map created by the collected spatial data relative to the visually captured image aspects. In the embodiment shown in FIG. 6, the cross section of the relief map is represented from most distant to nearest image characteristics, based on a respective distance of the camera lens from the visual. The visual is shown with its actual featured aspects (e.g., the mountains) at their actual respective distances from the camera lens of the system.

During colorization of black and white motion pictures, color information typically is added to “key frames” and several frames of uncolored film often has colors that are results of guesswork and often not in any way related to actual color of objects when initially captured on black and white film. The “Technicolor 3 strip” color separating process, captured and stored (within distinct strips of black and white film) a color “information record” for use in recreating displayable versions of the original scene, featuring color “added,” as informed by a representation of actual color present during original photography.

Similarly, in accordance with the teachings herein, spatial information captured during original image capture, may potentially inform (like the Technicolor 3 strip process), a virtually infinite number of “versions” of the original visual captured through the camera lens. For example, as “how much red” is variable in creating prints from a Technicolor 3 strip print, not forgoing that the dress was in fact red and not blue, the present invention allows for such a range of aesthetic options and application in achieving the desired effect (such as three-dimensional visual effect) from the visual and it's corresponding spatial “relief map” record. Thus, for example, spatial data may be gathered with selective detail, meaning “how much spatial data gathered per image” is a variable best informed by the discreteness of the intended display device or anticipated display device(s) of “tomorrow.” Based on the historic effect of originating films with sound, with color or the like, even before it was cost effective to capture and screen such material, the value of such projects for future use, application and system(s) compatibility is known. In this day of imaging progress, the value of gathering dimensional information described herein, even if not applied to a displayed version of the captured images for years, is potentially enormous and thus very relevant now for commercial presenters of imaged projects, including motion pictures, still photography, video gaming, television and other projects involving imaging.

Other uses and products provided by the present invention will be apparent to those skilled in the art. For example, in an embodiment, an unlimited number of image manifest areas are represented at different depths along the line of sight of a viewer. For example, a clear cube display that is ten feet deep, provides each “pixel” of an image at a different depth, based on each pixel's spatial and depth position from the camera. In another embodiment, a three-dimensional television screen is provided in which pixels are provided horizontally, e.g., left to right, but also near to far (e.g., front to back) selectively, with a “final” background area where perhaps more data appears than at some other depths. In front of the final background, foreground data occupy “sparse” depth areas, perhaps only a few pixels occurring at a specific depth point. Thus, image files may maintain image aspects in selectively varied forms, for example, in one file, the background is provided in a very soft focus (e.g., is imposed).

Therefore, although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for providing multi-dimensional visual information, the method comprising:
capturing an image with a camera, wherein the image includes visual aspects;
capturing spatial data relating to the visual aspects;
generating image data from the captured image; and
selectively transforming the image data as a function of the spatial data to provide the multi-dimensional visual information.

2. A system for capturing a lens image, the system comprising:
a camera operable to capture the lens image;
a spatial data collector that is operable to collect spatial data relating to at least one visual element within the captured visual; and
a computing device operable to use the spatial data to distinguish three-dimensional aspects of the captured visual.

3. The system of claim 2, wherein the three-dimensional aspects of the visual are manifested at selectively different distances relative to a viewer, based on the spatial data, wherein the distances include different points along a viewer's line of sight.

4. The system of claim 2, wherein the image is captured electronically.

5. The system of claim 2, wherein the image is captured digitally.

6. The system of claim 2, wherein the image is captured on photographic film.

7. The system of claim 2, further comprising offset information representing a physical location of the spatial data collector relative to a selected aspect of the camera, and further wherein the computing device uses the offset information to selectively adjust for offset distortion in the spatial data resulting from the physical location of the spatial data collector.

8. A system for capturing photographic images to provide a three-dimensional appearance, the system comprising:
a camera operable to capture an image;
a spatial data gathering device operable to collect and present spatial data relating to visual elements within the image;
a data recorder operable to record at least the spatial data; and
image data transforming software operable with a computing device for creating final images as a function of data relating to the image as affected by selective application of the spatial data.

9. The system of claim 8, wherein the data recorder operates subsequent to an operation of the camera and the spatial data gathering device to store at least the spatial data.

10. A system for capturing and screening multidimensional images, the system comprising:
a capture and recording device wherein distance data of visual elements represented visually within captured images are captured and recorded;
an allocation device operable to distinguish and allocate information within the captured image; and
a screening device operable to display the captured images, wherein the screening device includes a plurality of displays to display images in tandem, wherein the plurality of displays display the images at selectively different distances from a viewer.

11. A system for screening images, the system comprising:
a visual data capture device operable to capture visual data that represents a scene;
a non-visual data capture device operable to capture non-visual data that represents at least foreground and background elements of the visual data; and
a plurality of displays operable to display images at respective planes of at least one of a reflected and direct view assemblage of displayed visual data based on the captured visual data and the captured non-visual data, wherein the non-visual data informs allocation of foreground and background elements of the captured visual data to the respective planes of the plurality of displays.

12. The system of claim 11, wherein the displays are display screens having selected opacity.

13. The system of claim 11, wherein the visual data are derived from two differently focused aspects of a visual provided through a single lens.

14. The system of claim 11, wherein the visual data are derived from visual and spatial data collected selectively simultaneously at image capture.

15. The system of claim 11, wherein the non-visual data includes spatial data gathered from a vantage point relative to the visual data capture device.

16. The system of claim 11, further comprising an visual capture means, wherein spatial data are captured from vantage points other than the position of the image capture means.

17. The system of claim 11, wherein the image manifesting planes include a selectively reflective image manifesting foreground plane relative to the viewer, and opaque image reflecting rear image manifesting plane.

18. The system of claim 17, wherein the image manifesting planes are display screens.

19. The system of claim 17, wherein one of the plurality of image manifesting planes is a rear image manifesting plane that is a reflective projection screen.

20. The system of claim 17, wherein one of the plurality of image manifesting planes is a rear image manifesting plane is a direct view monitor.

21. A system for multidimensional imaging, the system comprising:
a computing device operable by a user;
a digital image transform program operable in the computing device in response to input provided by the user;
an image capture element operable to provide an image, wherein the program operates to apply selective zone isolation of data corresponding to aspects of the image based on distance data collected in tandem with the operation of the image capture element.

22. The system of claim 21, wherein the aspects include distinct objects identifiable within said image for generating at least one distinct digital file.

23. A system for capturing light relayed through a camera lens relating to a visual scene for capture as an image and subsequent delineation of aspects of said light as represented by said image, the system comprising:
a camera operable to capture an image;
a spatial data gathering device that is operable to capture and transmit spatial data relating to at least one visually discernable image aspect within the image relating to the visual scene; and
a storage device operable to store the spatial data transmitted by spatial data gathering device, wherein the spatial data distinguishes a plurality zones of the image for allocation of the zones to at least two distinct viewable image manifest areas occurring at select depths from an intended viewer, such depths of such areas including one further from an intended viewer than another, as measurable along that viewer's line of sight.

24. The system of claim 23, wherein the visually discernable image aspect is an identifiable object as capture as an element of the lens image.

25. The system of claim 23, wherein the spatial data distinguish an unlimited number of distinct viewable image manifest areas.
